(19) United States
(12) Patent Application Publication
(10) Pub. No.: US 2024/0230845 A1
(43) Pub. Date: Jul. 11, 2024

(54) DISTANCE MEASUREMENT DEVICE

(71) Applicant: SK hynix Inc., Icheon-si Gyeonggi-do (KR)

(72) Inventor: Toshiaki Nagai, Icheon-si Gyeonggi-do (KR)

(73) Assignee: SK hynix Inc., Icheon-si Gyeonggi-do (KR)

(21) Appl. No.: 18/323,872

(22) Filed: May 25, 2023

(30) Foreign Application Priority Data
Jan. 11, 2023 (KR) 10-2023-0003981

(51) Int. Cl. G01S 7/48; G01S 7/4863; G01S 7/4865

(52) U.S. Cl. CPC G01S 7/4808; G01S 7/4863; G01S 7/4865

(57) ABSTRACT

Provided herein is a distance measurement device. A device includes a first unit pixel to which a first modulation voltage having a designated phase and a second modulation voltage having a phase difference from the first modulation voltage are applied, a second unit pixel to which a third modulation voltage having a phase difference from the first modulation voltage and a fourth modulation voltage having a phase difference from the third modulation voltage are applied, and a data compression module configured to generate a compressed data set including data that is compressed compared to pixel data received from the first unit pixel and the second unit pixel based on the pixel data.

### CROSS-REFERENCE TO RELATED APPLICATION

The present application claims priority under 35 U.S.C. § 119(a) to Korean patent application number 10-2023-0003981 filed on Jan. 11, 2023, in the Korean Intellectual Property Office, the entire disclosure of which is incorporated by reference herein.

### BACKGROUND

### 1. Technical Field

Various embodiments of the present disclosure generally relate to a technology for measuring a distance, and more particularly, to a technology for measuring a distance to an external object using a time-of-flight (TOF) method.

### 2. Related Art

Recently, in various fields such as security, medical appliances, vehicles, game consoles, virtual reality (VR)/augmented reality (AR), and mobile devices, a demand for image sensors for measuring a distance to an external object has increased. Distance measurement methods may include a triangulation method, a time-of-flight (hereinafter referred to as “TOF”) method, interferometry, etc. Among the methods, the TOF method is a method of calculating a distance by measuring the time-of-flight of light or a signal, that is, the time during which light or a signal is reflected and returned from an external object after the light or the signal is output, and is advantageous in that the range of utilization thereof is wide, a processing speed is high, and a cost benefit is high.

Of various TOF methods, an indirect TOF method may emit a modulated light wave (hereinafter referred to as ‘modulated light’) through a light source, wherein the modulated light may have a sine wave, a pulse train or another periodic waveform. A TOF sensor detects reflected light that is modulated light reflected from a surface in an observed scene. An electronic device measures a phase difference between the emitted modulated light and the received reflected light, and calculates a physical distance (or depth) between the TOF sensor and the external object in the scene.

The TOF sensor measures the depth of the external object using two or more image frames. The electronic device stores raw data acquired from the TOF sensor in a frame memory through a serial interface in the TOF sensor. Therefore, the depth measurement performance of the electronic device varies depending on the capacity of the frame memory and the speed of the serial interface.

### SUMMARY

An embodiment of the present disclosure may provide for a device. The device may include a first unit pixel to which a first modulation voltage having a designated phase and a second modulation voltage having a phase difference from the first modulation voltage are applied, a second unit pixel to which a third modulation voltage having a phase difference from the first modulation voltage and a fourth modulation voltage having a phase difference from the third modulation voltage are applied, and a data compression module configured to generate a compressed data set including data that is compressed compared to pixel data received from the first unit pixel and the second unit pixel based on the pixel data.

An embodiment of the present disclosure may provide for a method. The method may include outputting modulated light corresponding to a designated phase through a light source, generating a first photocharge corresponding to reflected light that is modulated light reflected from an external object through a first unit pixel, and generating a second photocharge corresponding to the reflected light through a second unit pixel, capturing the first photocharge by applying a first modulation voltage having the designated phase and a second modulation voltage having a phase difference from the first modulation voltage to the first unit pixel, and capturing the second photocharge by applying a third modulation voltage having a phase difference from the first modulation voltage and a fourth modulation voltage having a phase difference from the third modulation voltage to the second unit pixel, acquiring pixel data through the first unit pixel and the second unit pixel, and generating a compressed data set including data that is compressed compared to the pixel data based on the pixel data.

### BRIEF DESCRIPTION OF THE DRAWINGS

FIG. 1 is a diagram schematically illustrating the configuration of a device according to an embodiment of the present disclosure.

FIG. 2 is a diagram illustrating an example of a method for measuring the depth of an external object using a phase difference between modulated light and reflected light according to an embodiment of the present disclosure.

FIG. 3 is a diagram illustrating an example of a method for measuring the depth of an external object using a phase difference between modulated light and reflected light according to an embodiment of the present disclosure.

FIG. 4 is a diagram illustrating an example of a method for measuring the depth of an external object using a phase difference between modulated light and reflected light according to an embodiment of the present disclosure.

FIG. 5 is a diagram illustrating a method of reducing data capacity according to an embodiment of the present disclosure.

FIG. 6 is a diagram illustrating the reason for using together a first unit pixel and a second unit pixel according to an embodiment of the present disclosure.

FIG. 7 is a flowchart illustrating a method of reducing data capacity by acquiring a compressed data set according to an embodiment of the present disclosure.

FIG. 8 is a flowchart illustrating a first method of compressing differential data according to an embodiment of the present disclosure.

FIG. 9 is a diagram illustrating an example of first compressed data and second compressed data acquired in a first situation according to the first method among embodiments of the present disclosure.

FIG. 10 is a diagram illustrating an example of first compressed data and second compressed data acquired in a second situation according to the first method among embodiments of the present disclosure.

FIG. 11 is a diagram illustrating an example of first compressed data and second compressed data acquired in a third situation according to the first method among embodiments of the present disclosure.

FIG. 12 is a diagram illustrating an example of first compressed data and second compressed data acquired in a fourth situation according to the first method among embodiments of the present disclosure.

FIG. 13 is a flowchart illustrating a second method of compressing pixel data according to an embodiment of the present disclosure.

FIG. 14 is a diagram illustrating an example of a compressed data set acquired in a first situation according to the second method among embodiments of the present disclosure.

FIG. 15 is a diagram illustrating an example of a compressed data set acquired in a second situation according to the second method among embodiments of the present disclosure.

FIG. 16 is a diagram illustrating an example of a compressed data set acquired in a third situation according to the second method among embodiments of the present disclosure.

FIG. 17 is a diagram illustrating an example of a compressed data set acquired in a fourth situation according to the second method among embodiments of the present disclosure.

FIG. 18 is a diagram illustrating the hardware configuration of a device according to various embodiments of the present disclosure.

FIG. 19 is a diagram illustrating the phases of modulation voltages applied to unit pixels for respective frames according to various embodiments of the present disclosure.

### DETAILED DESCRIPTION

Specific structural or functional descriptions in the embodiments of the present disclosure introduced in this specification or application are provided as examples to describe embodiments according to the concept of the present disclosure. The embodiments according to the concept of the present disclosure may be practiced in various forms, and should not be construed as being limited to the embodiments described in the specification or application.

Various embodiments of the present disclosure are directed to a distance measurement device, which reduces the capacity of data required for generation of a depth image using a TOF sensor while having improved performance.

Various embodiments of the present disclosure will now be described in detail with reference to the accompanying drawings so that those skilled in the art can practice the technical spirit of the present disclosure.

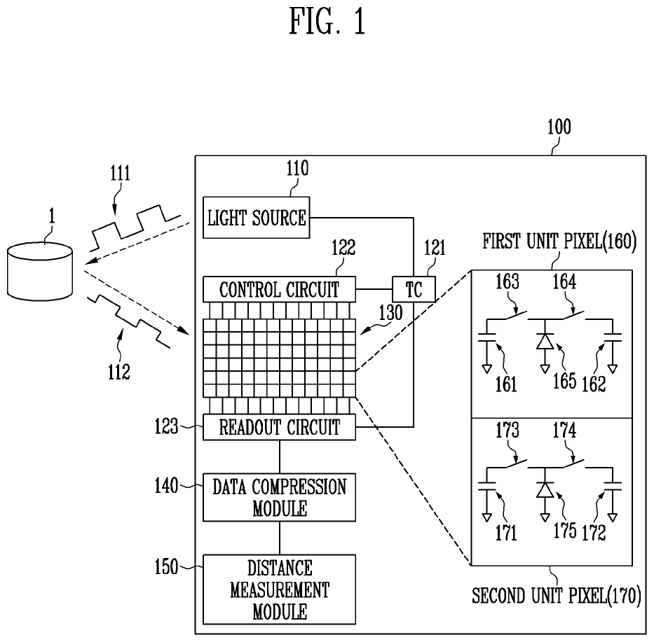

FIG. 1 is a diagram schematically illustrating the configuration of a device according to an embodiment of the present disclosure.

Referring to FIG. 1, a device 100 may include a light source 110, a timing controller (TC) 121, a control circuit 122, a readout circuit 123, a pixel array 130, a data compression module 140, and a distance measurement module 150. The device 100 may measure a distance to an external object 1 or the depth of the external object 1 using a TOF method. The TOF method may be a scheme for emitting modulated light to the external object 1, detecting reflected light that is incident after being reflected from the external object 1, and indirectly measuring the distance between the device 100 and the external object 1 based on a phase difference between the modulated light and the reflected light.

The light source 110 may emit light to the external object 1 in response to a light modulation signal provided from the timing controller 121. The light source 110 may be a laser diode (LD) configured to emit light in a specific wavelength band (e.g., a near-infrared ray, an infrared ray, or visible light), a light emitting diode (LED), a near-infrared laser (NIR), a point light source, a monochromatic illumination source in which a white lamp is combined with a monochromator, or a combination of other laser light sources. For example, the light source 110 may emit infrared light having a wavelength ranging from 800 nm to 1000 nm. The light emitted from the light source 110 may be modulated light that is modulated at a preset frequency. That is, the light source 110 may output modulated light corresponding to a designated phase. The designated phase may be a phase in which an active voltage and an inactive voltage are repeated at intervals of a designated period. The word “preset” or predetermined as used herein with respect to a parameter, such as a preset frequency and preset value or predetermined value, means that a value for the parameter is determined prior to the parameter being used in a process or algorithm. For some embodiments, the value for the parameter is determined before the process or algorithm begins. In other embodiments, the value for the parameter is determined during the process or algorithm but before the parameter is used in the process or algorithm.

The pixel array 130 may include a plurality of unit pixels successively arranged in a two-dimensional (2D) matrix structure. For example, the pixel array 130 may include unit pixels successively arranged in a row direction and a column direction. Each unit pixel may be the minimum unit by which the same pattern is repeatedly arranged on the pixel array 130. For example, the pixel array 130 may include first unit pixels 160 and second unit pixels 170. The first unit pixels 160 and the second unit pixels 170 may be arranged adjacent to each other.

Referring to FIG. 1, each first unit pixel 160 may include a photodiode 165, a first detection node 161, a first control node 163 configured to couple the photodiode 165 to the first detection node 161, a second detection node 162, and a second control node 164 configured to couple the photodiode 165 to the second detection node 162. The second unit pixel 170 may include a photodiode 175, a third detection node 171, a third control node 173 configured to couple the photodiode 175 to the third detection node 171, a fourth detection node 172, and a fourth control node 174 configured to couple the photodiode 175 to the fourth detection node 172. The device 100 may collect charges, generated by applying modulation voltages to the control nodes (e.g., 163, 164, 173, and 174), through the detection nodes (e.g., 161, 162, 171, and 172). The structure and shape of the control nodes (e.g., 163, 164, 173, and 174) and the detection nodes (e.g., 161, 162, 171, and 172) illustrated in FIG. 1 correspond to one example, and the scope of the present disclosure is not limited thereto. For example, each control node may have a shape enclosing the corresponding detection node. Further, the control nodes and the detection nodes may form taps (or sampling points). For example, a first tap may include the first control node 163 and the first detection node 161.

For example, each unit pixel may be a current-assisted photonic demodulator (CAPD) pixel. Each unit pixel may capture a photocharge generated in a substrate by incident light using the difference between the potentials of an electric field. For example, when the reflected light is incident on the first unit pixel 160, a first photocharge corresponding to the reflected light may be generated through a photoelectric conversion area (e.g., the substrate and the photodiode 165). A first modulation voltage and a second modulation voltage may be applied to the first control node 163 and the second control node 164 included in the first unit pixel 160, and a pixel current may be generated in the first unit pixel 160 by the applied modulation voltages. The device 100 may capture the first photocharge moved by the pixel current through the first detection node 161 and the second detection node 162. In FIG. 1, description of the first unit pixel 160 may also be applied to the second unit pixel 170.

The control circuit 122 may generate a control signal for selecting and controlling at least one of a plurality of row lines in the pixel array 130. The control signal may include at least some of a reset signal for controlling a reset transistor, a transfer signal for controlling the transfer of photocharges accumulated in a detection area, a floating diffusion signal for providing additional capacitance in a high-illuminance condition, and a select signal for controlling a select transistor.

The control circuit 122 may generate and output modulation voltages for generating a pixel current in the substrate of the unit pixels. The control circuit 122 may generate and output modulation voltages that are applied to the first control node 163, the second control node 164, the third control node 173, and the fourth control node 174, respectively.

The timing controller 121 may generate timing signals for controlling the operations of the light source 110, the control circuit 122, and the readout circuit 123.

The readout circuit 123 may generate digital signal-format pixel data by processing the pixel signals output from the pixel array 130 under the control of the timing controller 121. For example, the readout circuit 123 may acquire first pixel data from the first detection node 161, second pixel data from the second detection node 162, third pixel data from the third detection node 171, and fourth pixel data from the fourth detection node 172.

The readout circuit 123 may perform correlated double sampling (CDS) on pixel signals output from the pixel array 130. The device 100 may reduce readout noise included in the pixel signals through CDS. Further, the readout circuit 123 may include an analog-to-digital converter (ADC) for converting output signals on which CDS is performed into digital signals. Furthermore, the readout circuit 123 may include a buffer circuit which stores the pixel data output from the ADC and outputs the stored pixel data to an external device under the control of the timing controller 121.

Meanwhile, column lines through which pixel signals are transferred from the unit pixels to the readout circuit 123 may be provided such that at least one column line is implemented for each column of the pixel array 130, and components which process the pixel signals output from the column lines may also be provided to correspond to respective column lines.

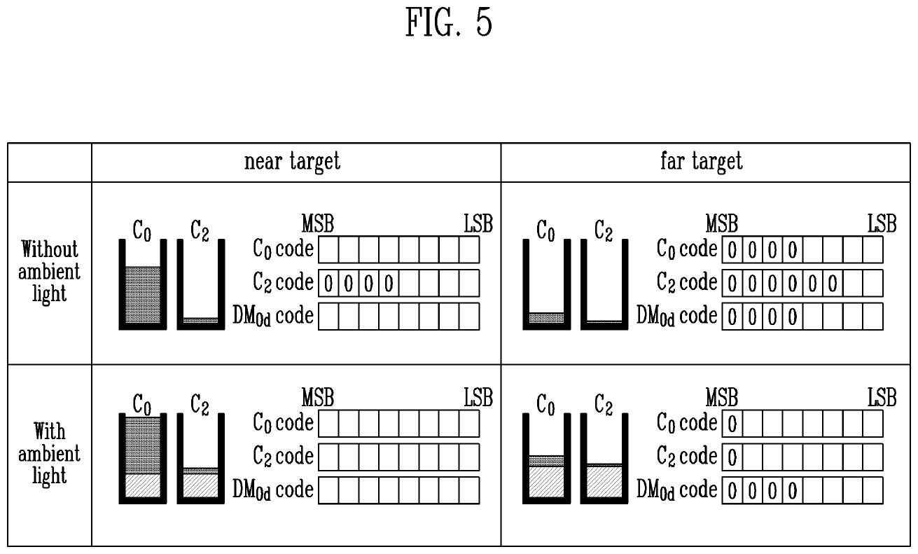

The data compression module 140 may compress the pixel data acquired through the readout circuit 123. For example, the data compression module 140 may acquire compressed data based on the first pixel data, the second pixel data, the third pixel data, and the fourth pixel data. Each of the first pixel data, the second pixel data, the third pixel data, and the fourth pixel data may be data having a first number of bits, and the compressed data may be data having a second number of bits less than the first number of bits. A method in which the data compression module 140 according to the present disclosure compresses pixel data will be described later with reference to FIG. 5 or subsequent drawings.

The distance measurement module 150 may receive the compressed data from the data compression module 140, and may calculate the distance between the device 100 and the external object 1 (or the depth of the external object 1) based on the compressed data. For example, when the light source 110 emits modulated light, which is modulated at a preset frequency, to a scene captured by the device 100 and the device 100 detects reflected light (or incident light), which is reflected from the external object 1 in the scene, a time delay depending on the distance between the device 100 and the external object 1 is present between the modulated light and the reflected light. When the phase of the modulated light corresponds to a first phase 111, the phase of the reflected light may correspond to a second phase 112 having a certain phase difference from the first phase 111. The distance measurement module 150 may calculate the distance to the external object 1 based on the phase difference between the first phase 111 and the second phase 112. The device 100 may generate a depth image including depth information for each unit pixel using the phase difference between the modulated light and the reflected light.

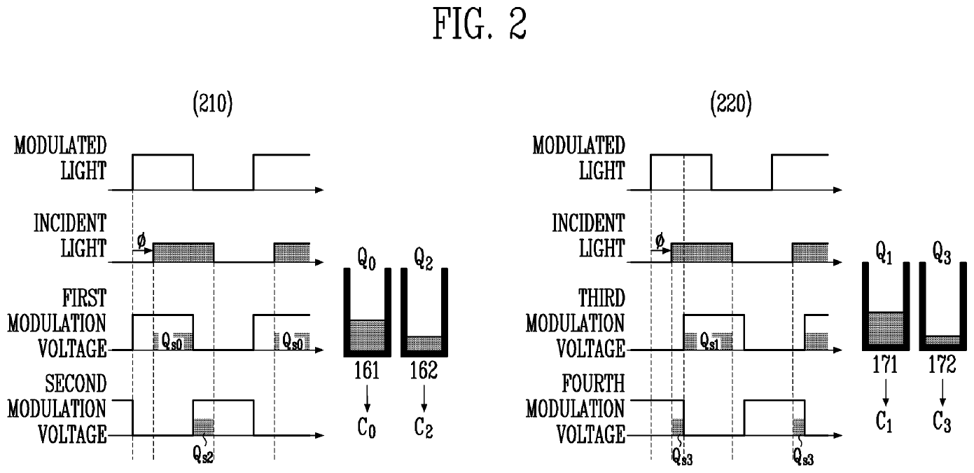

FIG. 2 is a diagram illustrating an example of a method for measuring the depth of an external object using a phase difference between modulated light and reflected light according to an embodiment of the present disclosure.

In FIG. 2, a method of calculating the distance d to an external object in the case where there is no or negligible ambient light will be described. When there is no or negligible ambient light, incident light may correspond to reflected light depending on modulated light. Reference numeral 210 may correspond to a first unit pixel 160, reference numeral 220 may correspond to a second unit pixel 170, and the device 100 may calculate a phase difference ϕ between the modulated light and the reflected light using the first unit pixel 160 and the second unit pixel 170. However, this is only an example, and reference numeral 210 and reference numeral 220 may correspond to a first image frame and a second image frame acquired through the first unit pixel 160.

Referring to FIG. 2, the modulated light may have a designated phase, and the reflected light may have a certain phase difference ϕ from the modulated light. For example, the designated phase may be the first phase 111 described above with reference to FIG. 1.

Referring to reference numeral 210, a first modulation voltage having the designated phase may be applied to the first control node 163 of the first unit pixel 160 and a second modulation voltage having a phase difference of 180 degrees from the first modulation voltage may be applied to the second control node 164 of the first unit pixel 160. While the first modulation voltage is applied to the first control node 163, a charge amount of Qₛ₀ may be accumulated in the first detection node 161. While the second modulation voltage is applied to the second control node 164, a charge amount of Qₛ₂ may be accumulated in the second detection node 162. The device 100 may repeat the above-described accumulation of charges N times. The charge amounts accumulated in the first detection node 161 and the second detection node 162, respectively during a certain period of time may be Q₀, and Q₂. The readout circuit 123 may read out the charge amounts accumulated in the first detection node 161 and the second detection node 162, respectively, and may then acquire pieces of pixel data C₀ and C₂ proportional to the respective charge amounts Q₀ and Q₂. In the present disclosure, C₀ may be referred to as the first pixel data, and C₂ may be referred to as the second pixel data.

Referring to reference numeral 220, the device 100 may apply a third modulation voltage having a phase difference of 90 degrees from the first modulation voltage to the third control node 173 of the second unit pixel 170, and may apply a fourth modulation voltage having a phase difference of 180 degrees from the third modulation voltage to the fourth control node 174 of the second unit pixel 170. While the third modulation voltage is applied to the third control node 173, a charge amount of Qₛ₁ may be accumulated in the third detection node 171. Furthermore, while the fourth modulation voltage is applied to the fourth control node 174, a charge amount of Qₛ₃ may be accumulated in the fourth detection node 172. The device 100 may repeat the above-described accumulation of charges N times. The charge amounts accumulated in the third detection node 171 and the fourth detection node 172, respectively, during a certain period of time may be Q₁ and Q₃. The readout circuit 123 may read out the charge amounts accumulated in the third detection node 171 and the fourth detection node 172, respectively, and may then acquire pieces of pixel data C₁ and C₃ proportional to the respective charge amounts Q₁ and Q₃. In the present disclosure, C₁ may be referred to as the third pixel data, and C₃ may be referred to as the fourth pixel data.

The device 100 may calculate the phase difference ϕ between the modulated light and the reflected light using the pieces of pixel data C₀, C₂, C₁, and C₃ acquired through the first detection node 161, the second detection node 162, the third detection node 171, and the fourth detection node 172. The phase difference ϕ may be calculated based on the following Equation 1:

$$ϕ = {tan}^{- 1} \frac{{Q}_{s 1} - {Q}_{s 3}}{{Q}_{s 0} - {Q}_{s 2}} = {tan}^{- 1} \frac{N ( {Q}_{s 1} - {Q}_{s 3} )}{N ( {Q}_{s 0} - {Q}_{s 2} )} = {tan}^{- 1} \frac{{Q}_{1} - {Q}_{3}}{{Q}_{0} - {Q}_{2}} = {tan}^{- 1} \frac{{C}_{1} - {C}_{3}}{{C}_{0} - {C}_{2}} = {tan}^{- 1} \frac{{DM}_{90 d}}{{DM}_{0 d}} \qquad ( 1 )$$

Referring to Equation 1, the phase difference ϕ may be calculated based on the difference between the charge amount Qₛ₀ accumulated in the first detection node 161 and the charge amount Qₛ₂ accumulated in the second detection node 162 and the difference between the charge amount Qₛ₁ accumulated in the third detection node 171 and the charge amount Qₛ₃ accumulated in the fourth detection node 172. Here, the charge amounts Q₀, Q₂, Q₁, and Q₃ of respective detection nodes may be acquired by multiplying N by the charge amounts Qₛ₀, Qₛ₂, Qₛ₁, and Qₛ₃ accumulated in respective detection nodes. For example, for the first detection node 161, Q₀=NQₛ₀ may be acquired. For example, for the second detection node 162, Q₂=NQₛ₂ may be acquired. The first unit pixel 160 may output pieces of pixel data C₀ and C₂ proportional to the charge amounts Q₀ and Q₂, respectively. Furthermore, the second unit pixel 170 may output pieces of pixel data C₁ and C₃ proportional to the charge amounts Q₁ and Q₃, respectively. Therefore, the device 100 may calculate the phase difference ϕ using the pieces of pixel data C₀, C₂, C₁, and C₃ output from respective detection nodes, as shown in Equation 1.

That is, the device 100 may calculate the phase difference ϕ based on the difference between the first pixel data C₀ of the first detection node 161 and the second pixel data C₂ of the second detection node 162 and the difference between the third pixel data C₁ of the third detection node 171 and the fourth pixel data C₃ of the fourth detection node 172. In Equation 1, DM_{0d} may correspond to differential data when photocharge is captured using a modulation voltage (e.g., the first modulation voltage) having a designated phase, and DM_{90d} may correspond to differential data when photocharge is captured using a modulation voltage (e.g., the third modulation voltage) having a phase difference of 90 degrees from the designated phase.

The device 100 may calculate the distance d between the external object 1 and the device 100 based on the phase difference ϕ acquired through Equation 1. For example, the device 100 may calculate the distance d based on the following Equation 2: In Equation 2, c denotes the speed of light, and f_{mod} denotes a modulation frequency.

$$d = \frac{1}{2} \frac{c}{{f}_{mod}} \frac{ϕ}{2 π} \qquad ( 2 )$$

That is, referring to FIG. 2, in the situation in which there is no or negligible ambient light, the device 100 may calculate the distance d between the device 100 and the external object 1 using the pieces of pixel data C₀, C₁, C₂, and C₃ acquired from respective detection nodes.

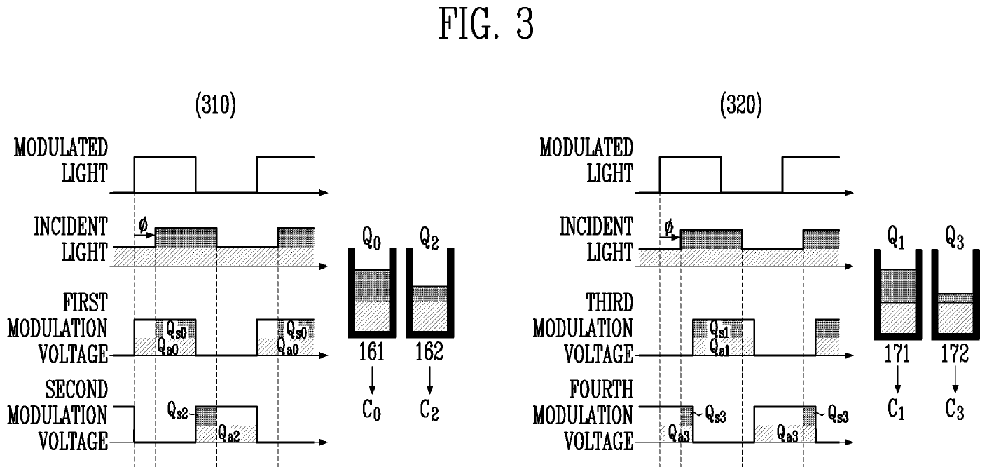

FIG. 3 is a diagram illustrating an example of a method for measuring the depth of an external object using a phase difference between modulated light and reflected light according to an embodiment of the present disclosure.

In FIG. 3, a method in which the device 100 calculates a distance d to an external object 1 in the case where ambient light is further present in addition to reflected light depending on modulated light will be described. Reference numeral 310 may correspond to a first unit pixel 160, reference numeral 320 may correspond to a second unit pixel 170, and the device 100 may calculate a phase difference ϕ between the modulated light and the reflected light using the first unit pixel 160 and the second unit pixel 170. In the configuration illustrated in FIG. 3, repeated description of the configuration identical to that of FIG. 2 will be omitted.

Referring to FIG. 3, in addition to the reflected light depending on the modulated light, ambient light may be further included in incident light. Therefore, Qₛ₀ corresponding to the reflected light and Qₐ₀ corresponding to the ambient light may be captured in the first detection node 161 to which a first modulation voltage is applied, Qₛ₂ corresponding to the reflected light and Qₐ₂ corresponding to the ambient light may be captured in the second detection node 162 to which a second modulation voltage is applied, Qₛ₁ corresponding to the reflected light and Qₐ₁ corresponding to the ambient light may be captured in the third detection node 171 to which a third modulation voltage is applied, and Qₛ₃ corresponding to the reflected light and Qₐ₃ corresponding to the ambient light may be captured in the fourth detection node 172 to which a fourth modulation voltage is applied.

Assuming the situation in which the ambient light is uniform, Qₐ₀, Qₐ₁, Qₐ₂, and Qₐ₃ may be values equal to each other. Therefore, the device 100 may calculate the phase difference ϕ between the modulated light and the reflected light using the following Equation 3:

$$ϕ = {tan}^{- 1} \frac{{Q}_{s 1} - {Q}_{s 3}}{{Q}_{s 0} - {Q}_{s 2}} = {tan}^{- 1} \frac{N ( {Q}_{s 1} - {Q}_{s 3} )}{N ( {Q}_{s 0} - {Q}_{s 2} )} = {tan}^{- 1} \frac{N \{ ( {Q}_{s 1} + {Q}_{a 1} ) - ( {Q}_{s 3} + {Q}_{a 3} ) \}}{N \{ ( {Q}_{s 0} + {Q}_{a 0} ) - ( {Q}_{s 2} + {Q}_{a 2} ) \}} = {tan}^{- 1} \frac{{Q}_{1} - {Q}_{3}}{{Q}_{0} - {Q}_{2}} = {tan}^{- 1} \frac{{C}_{1} - {C}_{3}}{{C}_{0} - {C}_{2}} = {tan}^{- 1} \frac{{DM}_{90 d}}{{DM}_{0 d}} \qquad ( 3 )$$

Referring to Equation 3, the phase difference ϕ may be calculated based on the charge amounts Qₛ₀, Qₛ₂, Qₛ₁, and Qₛ₃ corresponding to the reflected light among the charge amounts accumulated in respective detection nodes. Here, it may be difficult for the device 100 to separate only the charge amount Qₛ corresponding to the reflected light from charge amounts Qₛ+Qₐ accumulated in respective detection nodes. However, in an environment in which the ambient light is uniform, Qₐ₀, Qₐ₁, Qₐ₂, and Qₐ₃ may be the same value, and thus the device 100 may calculate the phase difference ϕ by adding Qₛ corresponding to the ambient light to the charge amounts Qₐ corresponding to the reflected light and accumulated in respective detection nodes. Also, similar to Equation 1, the charge amounts Q₀, Q₂, Q₁, and Q₃ of respective detection nodes may be acquired by multiplying N by the charge amounts Qₛ₀+Qₐ₀, Qₛ₂+Qₐ₂, Qₛ₁+Qₐ₁, Qₛ₃+Qₐ₃ accumulated in respective detection nodes. For example, for the first detection node 161, Q₀=N(Qₛ₀+Qₐ₀) may be acquired. For example, for the second detection node 162, Q₂=N(Qₛ₂+Qₐ₂) may be acquired. The first unit pixel 160 may output pieces of pixel data C₀ and C₂ proportional to the charge amounts Q₀ and Q₂, respectively. Further, the second unit pixel 170 may output pieces of pixel data C₁ and C₃, proportional to the charge amounts Q₁ and Q₃, respectively. Therefore, similar to Equation 1, the device 100 may calculate the phase difference ϕ using the pieces of pixel data output from respective detection nodes.

That is, comparing Equation 1 with Equation 3, the device 100 may calculate the phase difference ϕ using the same equation in the case where ambient light is negligible, as described above with reference to FIG. 2, and in the case where ambient light is present, as described above with reference to FIG. 3. The device 100 may calculate the distance d by applying Equation 2 to the phase difference ϕ acquired through Equation 3.

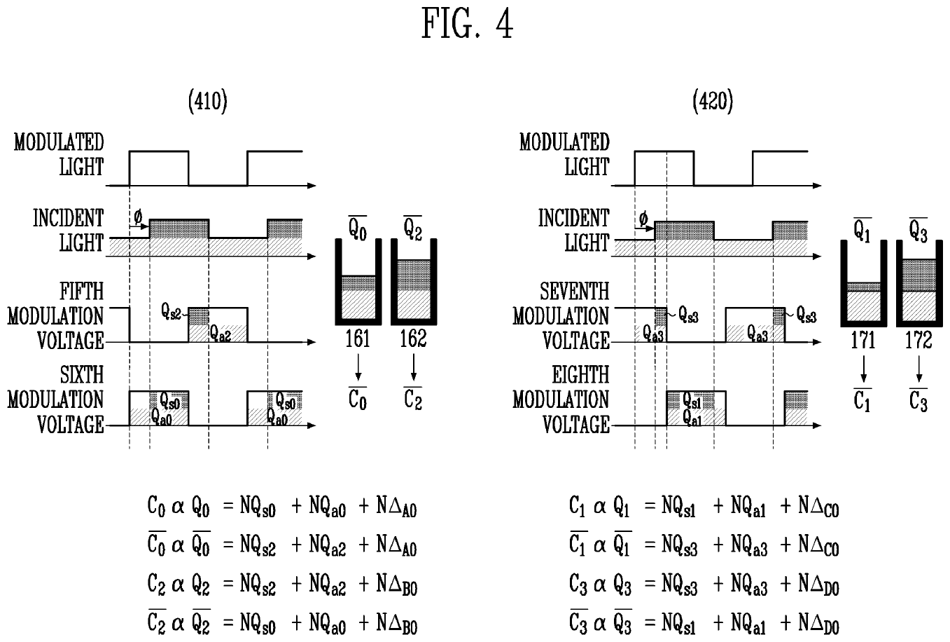

FIG. 4 is a diagram illustrating an example of a method for measuring the depth of an external object using a phase difference between modulated light and reflected light according to an embodiment of the present disclosure.

FIG. 4 illustrates a method for reducing an error attributable to mismatch between control nodes and more accurately calculating a distance d by utilizing a modulation voltage (e.g., a fifth modulation voltage) having a phase difference of 180 degrees from a designated phase and a modulation voltage (e.g., a seventh modulation voltage) having a phase difference of 270 degrees from the designated phase, together with C₀, C₁, C₂, and C₃, acquired in FIG. 3. For example, FIG. 3 may illustrate a first image frame and a second image frame acquired through the first unit pixel 160 and the second unit pixel 170, illustrated in FIG. 1, and FIG. 4 may illustrate a third image frame and a fourth image frame acquired through the first unit pixel 160 and the second unit pixel 170 illustrated in FIG. 1. In an example, reference numerals 310, 320, 410, and 420 may correspond to first to fourth image frames acquired through the first unit pixel 160.

The device 100 may apply the fifth modulation voltage having a phase difference of 180 degrees from a designated phase to the first control node 163, may apply a sixth modulation voltage having a phase difference of 180 degrees from the fifth modulation voltage to the second control node 164, may apply a seventh modulation voltage having a phase difference of 270 degrees from the designated phase to the third control node 173, and may apply an eighth modulation voltage having a phase difference of 180 degrees from the seventh modulation voltage to the fourth control node 174.

In FIG. 4, pieces of pixel data respectively corresponding to the charge amounts Q̅₀̅, Q̅₂̅, Q̅₁̅, and Q̅₃̅ accumulated in the first detection node 161, the second detection node 162, the third detection node 171, and the fourth detection node 172 may be referred to as C̅₀̅, C̅₂̅, C̅₁̅, and C̅₃̅. Comparing reference numeral 310 of FIG. 3 and reference numeral 410 of FIG. 4 with each other, a difference of 180 degrees may occur between the phases of the modulation voltages applied to the first control node 163 and to the second control node 164. Therefore, Q̅₀̅=N(Qₛ₂+Qₐ₂) and Q̅₂̅=N(Qₛ₀+Qₐ₀) may be satisfied. Here, when description is made based on the first unit pixel 160, an error value NΔ_{A0} attributable to a control error or a driving error between the first detection node 161 and the second detection node 162 may be present in each of Q₀ and Q̅₀̅, and an error value NΔ_{B0} attributable to a control error or a driving error between the first detection node 161 and the second detection node 162 may be present in each of Q₂ and Q̅₂̅. However, the relational expression in Equation 4, the error values may be offset.

$$\frac{1}{2} \{ ( {C}_{0} - {C}_{2} ) - ( \overline{{C}_{0}} - \overline{{C}_{2}} ) \} = N ( {Q}_{s 0} - {Q}_{s 2} ) \qquad ( 4 )$$

Similarly, for the second unit pixel 170, the relationship of Equation 5 may be established.

$$\frac{1}{2} \{ ( {C}_{1} - {C}_{3} ) - ( \overline{{C}_{1}} - \overline{{C}_{3}} ) \} = N ( {Q}_{s 1} - {Q}_{s 3} ) \qquad ( 5 )$$

Referring to Equations 1, 4, and 5, the device 100 may calculate the phase difference ϕ between the modulated light and the reflected light, based on the following Equation 6:

$$ϕ = {tan}^{- 1} \frac{{Q}_{s 1} - {Q}_{s 3}}{{Q}_{s 0} - {Q}_{s 2}} = {tan}^{- 1} \frac{( {C}_{1} - {C}_{3} ) - ( \overline{{C}_{1}} - \overline{{C}_{3}} )}{( {C}_{0} - {C}_{2} ) - ( \overline{{C}_{0}} - \overline{{C}_{2}} )} = {tan}^{- 1} \frac{{DM}_{90 d} - {DM}_{270 d}}{{DM}_{0 d} - {DM}_{180 d}} \qquad ( 6 )$$

Referring to FIGS. 2 to 4, the device 100 may acquire the distance d to the external object 1 (or the depth of the external object 1) using the pieces of pixel data pixel data (e.g., C₀, C₁, C₂, C₃) and/or pieces of differential data (e.g., DM_{0d}, DM_{90d}) which are acquired through respective detection nodes. However, compared to the existing device using pixel data and/or differential data in a raw data state, the present disclosure may reduce the size of storage space of a required frame memory and save the bandwidth of a required serial interface, by compressing the pixel data and/or differential data and then reducing data capacity.

FIG. 5 is a diagram illustrating a method of reducing data capacity according to an embodiment of the present disclosure.

In FIG. 5, examples of first pixel data C₀ and second pixel data C₂ acquired through a first detection node 161 and a second detection node 162 illustrated in FIG. 1 depending on the environment surrounding the device 100 are illustrated. For example, as the external object 1 is near to the device 100, the difference between C₀ and C₂ may be larger, whereas as the external object 1 is farther away from the device 100, the difference between C₀ and C₂ may be smaller. Further, compared to the situation in which there is no ambient light, in the situation in which ambient light is present, the values of C₀ and C₂ may be larger due to photocharges corresponding to the ambient light.

In FIG. 5, C₀ code, C₂ code, and DM_{0d} code may indicate data codes respectively represented by hexadecimal numbers. Further, in portions not padded with 0 in respective codes, numbers ranging from 0 to 15 may be included. For example, in the situation in which the external object 1 is near to the device 100 and no ambient light is present, C₀ code may be 0x8395DF14, and C₂ code may be 0x00001FA1. In an example, in the external object 1 is farther away from the device 100 and no ambient light is present, C₀ code may be 0x0000F30B, and C₂ code may be 0x00000072.

In the present disclosure, in order to reduce the capacity of the pixel data C₀ and C₂ or the differential data DM_{0d}, n bits ranging from the most significant bit (MSB) or the least significant bit (LSB) of each code or n bits ranging from of each bit may be omitted. The device 100 may determine the positions of bits to be omitted by separating the situation in which the external object 1 is near to the device 100, that is, the case in which the difference between C₀ and C₂ is larger, and the situation in which the external object 1 is farther away from the device 100, that is, the case where the difference between C₀ and C₂ is smaller. For example, as in the case where the external object 1 is farther away from the device 100, when DM_{0d} code includes four 0's ranging from the MSB, the device 100 may omit four bits from the MSB of the DM_{0d} code. In an example, in the situation in which the external object 1 is near to the device 100, four bits from the LSB of the DM_{0d} code may be omitted.

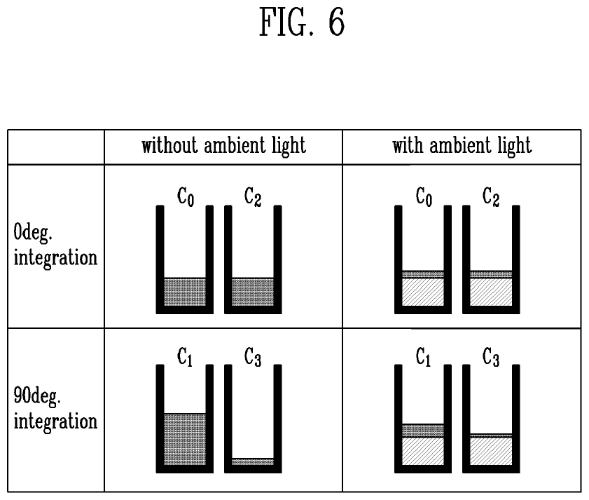

FIG. 6 is a diagram illustrating the reason for using a first unit pixel and a second unit pixel together according to an embodiment of the present disclosure.

As illustrated in FIG. 5, the device 100 may determine the positions of bits to be omitted among a first number of bits of pixel data C₀ and C₂ or differential data DM_{0d} using information about whether the difference between C₀ and C₂ is equal to or greater than a certain level. However, when the values of C₀ and C₂ are equal to each other, in some embodiments, it may be difficult to determine the bits to be omitted using the method described in relation to FIG. 5.

Referring to FIG. 6, when a phase difference between modulated light and reflected light is close to 90 degrees, the values of C₀ and C₂ may be similar to each other. For example, when the phase difference between the modulated light and the reflected light is 90 degrees even in the situation in which the external object 1 is near to the device 100, C₀ and C₂ may have the same value.

The device 100 according to the present disclosure 100 may determine the bits to be omitted using two unit pixels to which modulation voltages having a phase difference of 90 degrees are applied. In an example, the device 100 apply a first modulation voltage corresponding to a designated phase to the first control node 163 of the first unit pixel 160 illustrated in FIG. 1 and may apply a third modulation voltage having a phase difference of 90 degrees from the first modulation voltage to the third control node 173 of the second unit pixel 170. The device 100 may determine the positions of bits to be omitted using the values C₁ and C₃ acquired from the second unit pixel 170 even when the phase difference between the modulated light and the reflected light is 90 degrees and the values of C₀ and C₂ are very similar to each other.

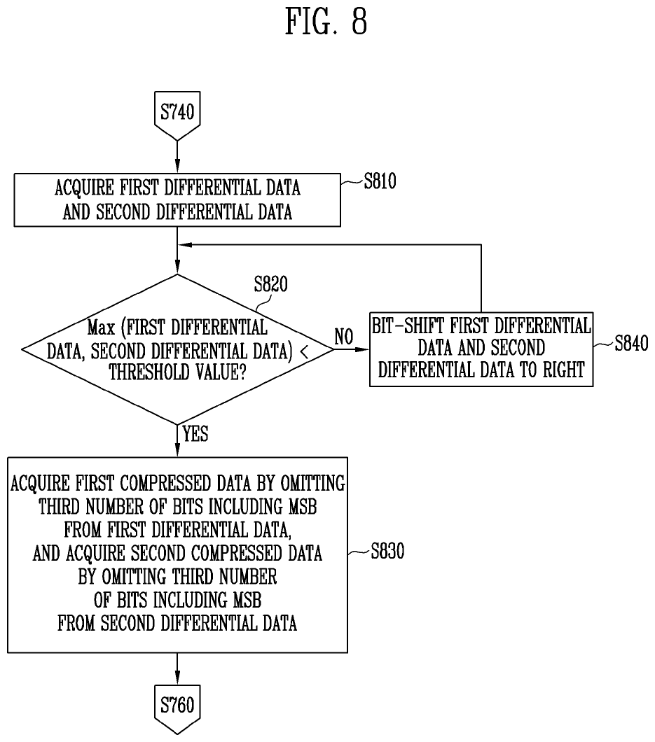

The device 100 may determine the positions of bits to be omitted based on differential data, having a larger value, of first differential data DM_{0d} corresponding to the difference between the first pixel data C₀ and the second pixel data C₂ acquired from the first unit pixel 160 and second differential data DM_{90d} corresponding to the difference between the third pixel data C₁ and the fourth pixel data C₃ acquired from the second unit pixel 170. A detailed method of data compression through bit omission will be described later with reference to FIG. 8 and subsequent drawings.

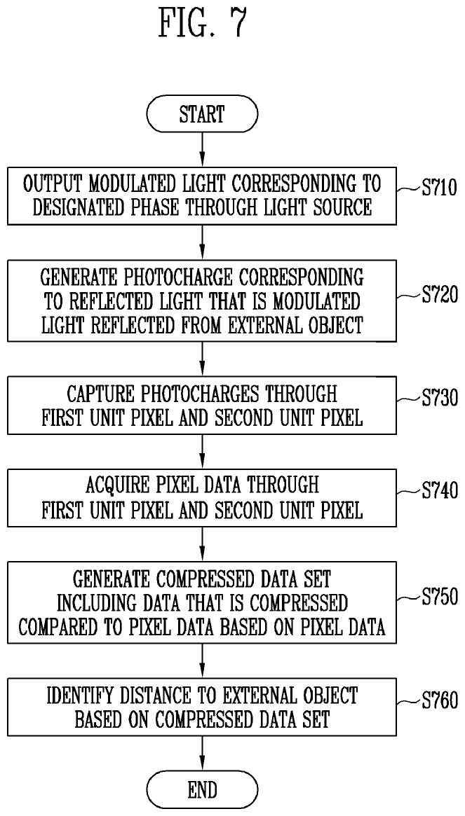

FIG. 7 is a flowchart illustrating a method of reducing data capacity by acquiring a compressed data set according to an embodiment of the present disclosure.

Referring to FIGS. 7 and 1 together, at step S710, the device 100 may output modulated light corresponding to a designated phase through the light source 110.

At step S720, the device 100 may generate photocharges corresponding to reflected light that is modulated light reflected from the external object 1. For example, the device 100 may generate a first photocharge corresponding to the reflected light through the first unit pixel 160, and may generate a second photocharge corresponding to the reflected light through the second unit pixel 170.

At step S730, the device 100 may capture the photocharges through the first unit pixel 160 and the second unit pixel 170. The device 100 may capture the first photocharge using the first detection node 161 and the second detection node 162 included in the first unit pixel 160, and may capture the second photocharge using the third detection node 171 and the fourth detection node 172 included in the second unit pixel 170. For example, the device 100 may generate a pixel current in the first unit pixel 160 by applying a first modulation voltage and a second modulation voltage to the first control node 163 and the second control node 164, respectively, and may capture the first photocharge transferred by the pixel current using the first detection node 161 and/or the second detection node 162. The first modulation voltage may have the designated phase, and the second modulation voltage may have a phase difference of 180 degrees from the first modulation voltage. Further, the device 100 may generate a pixel current in the second unit pixel 170 by applying a third modulation voltage and a fourth modulation voltage to the third control node 173 and the fourth control node 174, respectively, and may capture the second photocharge transferred by the pixel current using the third detection node 171 and/or the fourth detection node 172. The third modulation voltage may have a phase difference of 90 degrees from the first modulation voltage, and the fourth modulation voltage may have a phase difference of 180 degrees from the third modulation voltage.

At step S740, the device 100 may acquire pieces of pixel data through the first unit pixel 160 and the second unit pixel 170. The readout circuit 123 may acquire first pixel data C₀, second pixel data C₂, third pixel data C₁, and fourth pixel data C₃, each having a first number of bits, from the first detection node 161, the second detection node 162, the third detection node 171, and the fourth detection node 172, and the data compression module 140 may receive the first pixel data C₀, the second pixel data C₂, the third pixel data C₁, and the fourth pixel data C₃ from the readout circuit 123.

At step S750, the device 100 may generate a compressed data set including data that is compressed compared to the pixel data based on the pixel data. The device 100 (e.g., the data compression module 140) may generate a compressed data set including pieces of compressed data, each having a second number of bits less than the first number of bits, based on the first pixel data C₀, the second pixel data C₂, the third pixel data C₁, and the fourth pixel data C₃.

For example, the compressed data set may include first compressed data corresponding to first differential data DM_{0d} and second compressed data corresponding to second differential data DM_{90d}. A method of compressing the differential data will be described in detail later with reference to FIGS. 8 to 12. The compression method to be described with reference to FIGS. 8 to 12 will be referred to as a first method.

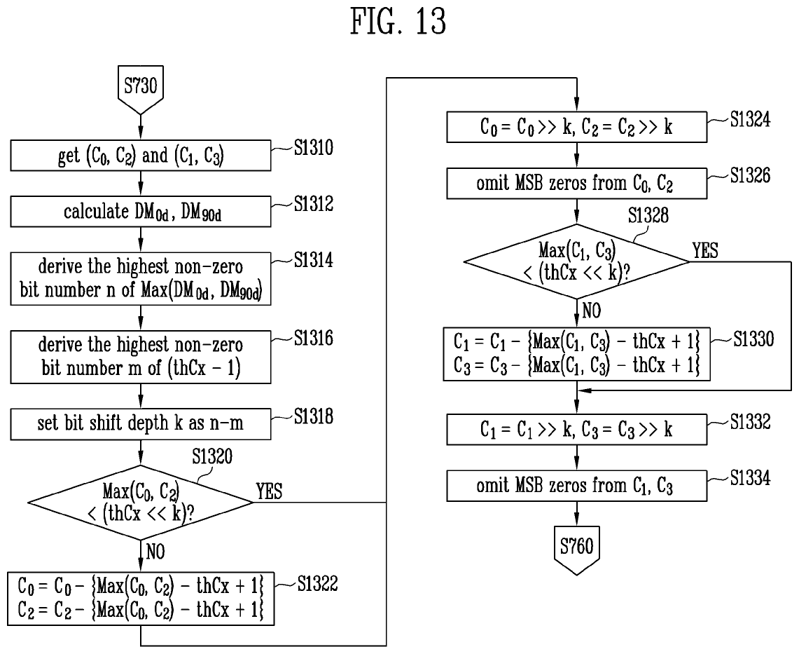

In an example, the compressed data set may include pieces of first to four compressed data respectively corresponding to the first pixel data C₀, the second pixel data C₂, the third pixel data C₁, and the fourth pixel data C₃. A method of compressing the pixel data will be described in detail later with reference to FIGS. 13 to 17. The compression method to be described with reference to FIGS. 13 to 17 will be referred to as a second method.

At step S760, the device 100 (e.g., the distance measurement module 150) may calculate a distance d to the external object 1 based on the compressed data set. For example, the device 100 may calculate the phase difference ϕ between modulated light and reflected light using the compressed data included in the compressed data set, and may calculate the distance d based on the phase difference. In an embodiment, step S760 may be skipped.

FIG. 8 is a flowchart illustrating a first method of compressing differential data according to an embodiment of the present disclosure. It may be understood that steps to be described in FIG. 8 are intended to describe step S750 in detail.

At step S810, the device 100 (e.g., the data compression module 140) may acquire first differential data DM_{0d} corresponding to the difference between the first pixel data C₀ and the second pixel data C₂, and second differential data DM_{90d} corresponding to the difference between the third pixel data C₁ and the fourth pixel data C₃. Each of the first differential data DM_{0d} and the second differential data DM_{90d} may have a first number of bits.

At step S820, the device 100 (e.g., the data compression module 140) may determine whether, of the first differential data DM_{0d} and the second differential data DM_{90d}, differential data having a larger value is less than a first threshold value. For example, the first threshold value may be 0x10000.

At step S830, the device 100 (e.g., the data compression module 140) may determine the bits to be omitted in response to determination that, of the first differential data DM_{0d} and the second differential data DM_{90d}, the differential data having a larger value is less than the first threshold value, and may acquire the compressed data. For example, the first compressed data may be acquired by omitting a third number of bits including a MSB from the first differential data DM_{0d}, and the second compressed data may be acquired by omitting a third number of bits including a MSB from the second differential data DM_{90d}.

At step S840, the device 100 (e.g., the data compression module 140) may bit-shift the first differential data DM_{0d} and the second differential data DM_{90d} to the right in response to determination that, of the first differential data DM_{0d} and the second differential data DM_{90d}, the differential data having a larger value is equal to or greater than the first threshold value. For example, the device 100 may divide the first differential data DM_{0d} and the second differential data DM_{90d} by 2. The device 100 may bit-shift the first differential data DM_{0d} and the second differential data DM_{90d} until, of the first differential data DM_{0d} and the second differential data DM_{90d}, the differential data having a larger value becomes less than the first threshold value at steps S820 and S840.

According to an embodiment of the first method, the device 100 may effectively reduce the capacity of data required for measuring the distance to the external object 1.

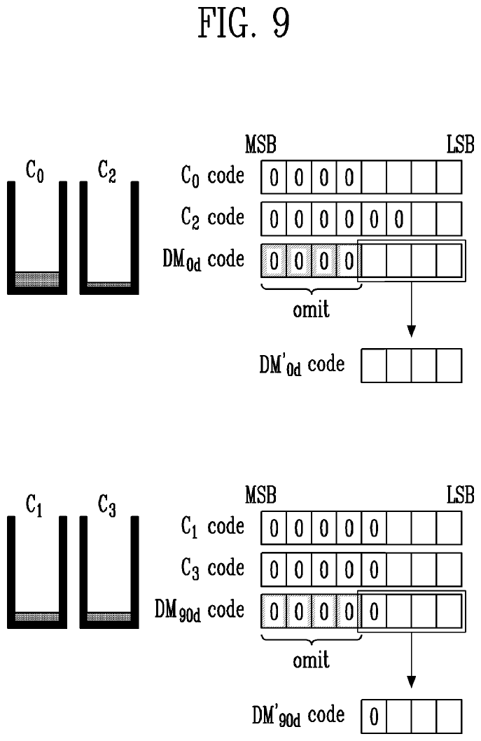

In FIGS. 9 to 12, a detailed example in which the device 100 performs steps of FIG. 8 and then compresses data depending on the situation around the device 100 will be described.

Referring to FIGS. 9 to 12, the situations around the device 100 may be distinguished from each other depending on whether ambient light is present and the distance between the device 100 and the external object 1. For example, as a first situation, the situation in which there is no or negligible ambient light and the external object 1 is farther away from the device 100 may be defined. As a second situation, the situation in which ambient light is present and the external object 1 is farther away from the device 100 may be defined. As a third situation, the situation in which there is no or negligible ambient light and the external object 1 is near to the device 100 may be defined. As a fourth situation, the situation in which ambient light is present and the external object 1 is near to the device 100 may be defined. However, the definition of situations might not be limited to the present specification, and may vary according to embodiments.

FIG. 9 is a diagram illustrating an example of first compressed data and second compressed data acquired in a first situation according to the first method among embodiments of the present disclosure.

Referring to FIG. 9, each of the first pixel data C₀ and the second pixel data C₂ in the first situation has a value smaller than those in the second to fourth situations, and the difference between the first pixel data C₀ and the second pixel data C₂ may also be small. Similarly, each of the third pixel data C₁ and the fourth pixel data C₃ in the first situation has a value smaller than those in the second to fourth situations, and the difference between the third pixel data C₁ and the fourth pixel data C₃ may also be small. For example, as illustrated in FIG. 9, each of C₀, C₂, C₁, and C₃ codes may have four to six 0's from a MSB.

In relation to step S820 of FIG. 8, the device 100 (e.g., the data compression module 140) may determine that, of the first differential data DM_{0d} and the second differential data DM_{90d}, the first differential data DM_{0d} having a larger value is less than the first threshold value (e.g., 0x10000).

Therefore, in relation to step S830 of FIG. 8, the device 100 (e.g., the data compression module 140) may omit a third number of bits including a MSB from the first differential data DM_{0d}, and may omit a third number of bits including a MSB from the second differential data DM_{90d}. For example, the device 100 may acquire first compressed data DM′_{0d} and second compressed data DM′90d by omitting four-digit codes starting from respective MSBs from the DM_{0d} code and the DM_{90d} code.

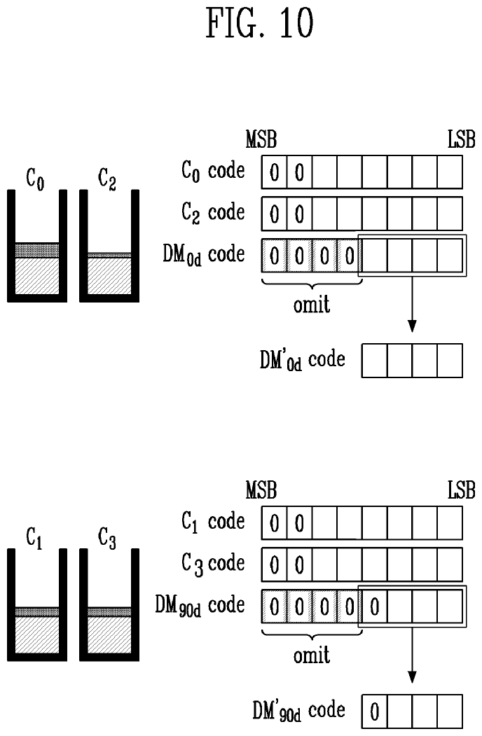

FIG. 10 is a diagram illustrating an example of first compressed data and second compressed data acquired in a second situation according to the first method among embodiments of the present disclosure.

Referring to FIG. 10, the difference between the first pixel data C₀ and the second pixel data C₂ in the second situation may be less than those in the third situation and the fourth situation. Furthermore, in the second situation, the difference between the third pixel data C₁ and the fourth pixel data C₃ may be less than the difference between the first pixel data C₀ and the second pixel data C₂. For example, as illustrated in FIG. 10, each of C₀, C₂, C₁, and C₃ codes may include two 0's from a MSB.

In relation to step S820 of FIG. 8, the device 100 (e.g., the data compression module 140) may determine that, of the first differential data DM_{0d} and the second differential data DM_{90d}, the first differential data DM_{0d} having a larger value is less than the first threshold value (e.g., 0x10000).

Therefore, in relation to step S830 of FIG. 8, the device 100 (e.g., the data compression module 140) may omit a third number of bits including a MSB from the first differential data DM_{0d}, and may omit a third number of bits including a MSB from the second differential data DM_{90d}. For example, the device 100 may acquire first compressed data DM′_{0d} and second compressed data DM′90d by omitting four-digit codes starting from respective MSBs from the DM_{0d} code and the DM_{90d} code.

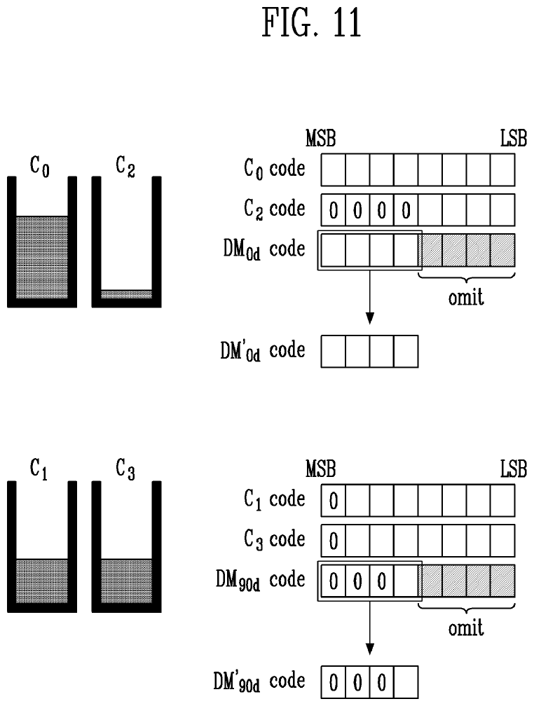

FIG. 11 is a diagram illustrating an example of first compressed data and second compressed data acquired in a third situation according to the first method among embodiments of the present disclosure.

Referring to FIG. 11, the difference between the first pixel data C₀ and the second pixel data C₂ in the third situation may be greater than those in the first situation and the second situation. Further, in the third situation, the difference between the third pixel data C₁ and the fourth pixel data C₃ may be less than the difference between the first pixel data C₀ and the second pixel data C₂. For example, pieces of pixel data corresponding to C₀, C₂, C₁, and C₃ codes such as those illustrated in FIG. 11 may be acquired.

In relation to step S820 of FIG. 8, the device 100 (e.g., the data compression module 140) may determine that, of the first differential data DM_{0d} and the second differential data DM_{90d}, the first differential data DM_{0d} having a larger value is equal to or greater than the first threshold value (e.g., 0x10000).

In relation to step S840 of FIG. 8, the device 100 (e.g., the data compression module 140) may bit-shift the first differential data DM_{0d} and the second differential data DM_{90d} to the right. For example, the device 100 may divide the first differential data DM_{0d} and the second differential data DM_{90d} by a power of 2 so that the first differential data DM_{0d} becomes less than the first threshold value (e.g., 0x10000).

In relation to step S830 of FIG. 8, the device 100 (e.g., the data compression module 140) may omit a third number of bits including a MSB from the bit-shifted first differential data DM_{0d} and omit a third number of bits including a MSB from the bit-shifted second differential data DM_{90d} in response to determination that the bit-shifted first differential data DM_{0d} is less than the first threshold value (e.g., 0x10000). Referring to FIG. 11, the device 100 may acquire first compressed data DM′_{0d} including the MSB of the first differential data DM_{0d} by omitting some bits from the first differential data DM_{0d}, and may acquire second compressed data DM′_{90d} including the MSB of the second differential data DM_{90d} by omitting some bits from the second differential data DM_{90d}. That is, when, of the pieces of differential data, the differential data having a larger value is equal to or greater than the first threshold value, the device 100 bit-shifts the pieces of differential data to the right, and thereafter omits a four-digit code having 0's starting from a MSB, and thus a four-digit code starting from the LSB of the differential data may be omitted.

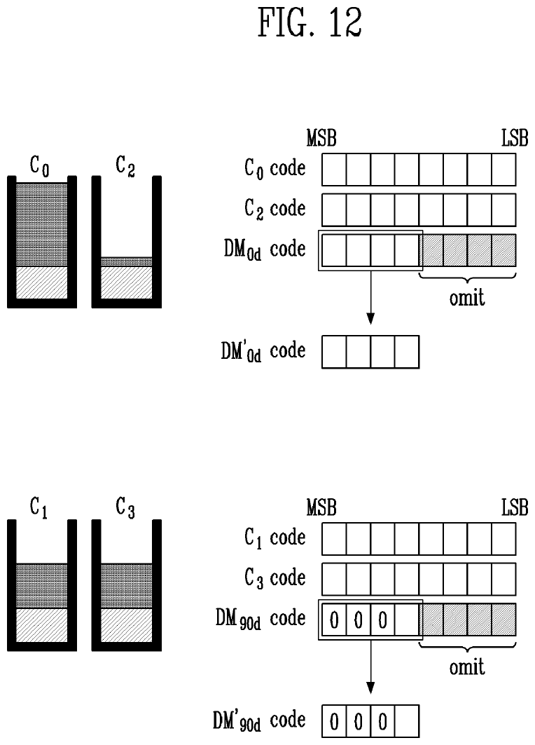

FIG. 12 is a diagram illustrating an example of first compressed data and second compressed data acquired in a fourth situation according to the first method among embodiments of the present disclosure.

Referring to FIG. 12, the difference between the first pixel data C₀ and the second pixel data C₂ in the fourth situation may be greater than those in the first situation and the second situation. Further, in the fourth situation, the difference between the third pixel data C₁ and the fourth pixel data C₃ may be less than the difference between the first pixel data C₀ and the second pixel data C₂. For example, pieces of pixel data corresponding to C₀, C₂, C₁, and C₃ codes such as those illustrated in FIG. 12 may be acquired.

In relation to step S820 of FIG. 8, the device 100 (e.g., the data compression module 140) may determine that, of the first differential data DM_{0d} and the second differential data DM_{90d}, the first differential data DM_{0d} having a larger value is equal to or greater than the first threshold value (e.g., 0x10000).

In relation to step S840 of FIG. 8, the device 100 (e.g., the data compression module 140) may bit-shift the first differential data DM_{0d} and the second differential data DM_{90d} to the right. For example, the device 100 may divide the shift the first differential data DM_{0d} and the second differential data DM_{90d} by the square of 2 so that the first differential data DM_{0d} is less than the first threshold value (e.g., 0x10000).

In relation to step S830 of FIG. 8, the device 100 (e.g., the data compression module 140) may omit a third number of bits including a MSB from the bit-shifted first differential data DM_{0d} and omit a third number of bits including a MSB from the bit-shifted second differential data DM_{90d} in response to determination that the bit-shifted first differential data DM_{0d} is less than the first threshold value (e.g., 0x10000). Referring to FIG. 12, the device 100 may acquire first compressed data DM′_{0d} including the MSB of the first differential data DM_{0d} by omitting some bits from the first differential data DM_{0d}, and may acquire second compressed data DM′_{90d} including the MSB of the second differential data DM_{90d} by omitting some bits from the second differential data DM_{90d}. That is, when, of the pieces of differential data, the differential data having a larger value is equal to or greater than the first threshold value, the device 100 bit-shifts the pieces of differential data to the right, and thereafter omits a four-digit code having 0's starting from a MSB, and thus a four-digit code starting from the LSB of the differential data may be omitted.

FIG. 13 is a flowchart illustrating a second method of compressing pixel data according to an embodiment of the present disclosure. It may be understood that steps to be described in FIG. 13 are intended to describe steps S740 and S750 in detail.

At step S1310, the device 100 (e.g., the data compression module 140) may acquire first pixel data C₀, second pixel data C₂, third pixel data C₁, and fourth pixel data C₃. Step S1310 may correspond to step S740 of FIG. 7.

At step S1312, the device 100 (e.g., the data compression module 140) may calculate first differential data DM_{0d} corresponding to the difference between the first pixel data C₀ and the second pixel data C₂, and second differential data DM_{90d} corresponding to the difference between the third pixel data C₁ and the fourth pixel data C₃.

At step S1314, the device 100 (e.g., the data compression module 140) may set the highest non-zero bit number in differential data having a larger value between the first differential data DM_{0d} and the second differential data DM_{90d} to n.

At step S1316, the device 100 (e.g., the data compression module 140) may set the highest non-zero bit number of a value, acquired by subtracting 1 from a second threshold value thCx (i.e., thCx−1), to m. For example, the second threshold value thCx may be 0x10000.

At step S1318, the device 100 (e.g., the data compression module 140) may set n-m as a bit shift depth k based on n and m acquired at steps S1312 and S1314.

At step S1320, the device 100 (e.g., the data compression module 140) may determine whether, of the first pixel data C₀ and the second pixel data C₂, pixel data having a larger value is less than a value acquired by bit-shifting the threshold value thCx to the left by k (or third threshold value=thCx<<k).

At step S1322, the device 100 (e.g., the data compression module 140) may subtract a preset value from each of the first pixel data C₀ and the second pixel data C₂ in response to determination that, of the first pixel data C₀ and the second pixel data C₂, the pixel data having a larger value is equal to or greater than the third threshold value (thCx<<k). For example, a value, which is acquired by subtracting the second threshold value thCx from the larger value of C₀ and C₂ and by adding 1 to a subtraction result (e.g., Max(C₀, C₂)−thCx+1), may be subtracted from each of C₀ and C₂.

At step S1324, the device 100 (e.g., the data compression module 140) may bit-shift each of the first pixel data C₀ and the second pixel data C₂ to the right by k in response to determination that, of the first pixel data C₀ and the second pixel data C₂, the pixel data having a larger value is less than the third threshold value (thCx<<k). Alternatively, the device 100 may bit-shift C₀ and C₂, from which the preset value is subtracted at step S1322, to the right by k.

At step S1326, the device 100 (e.g., the data compression module 140) may acquire first compressed data and second compressed data by omitting a designated number of bits starting from the MSB of C₀ and C₂ acquired at step S1324.

Description of steps S1320 to S1326 may be respectively applied to steps S1328 to S1334. Referring to the following Equation 7, the phase difference ϕ may have the same value even though a specific value is subtracted from each of C₀, C₁, C₂, and C₃ and each result value is divided by a power of 2 based on steps described in FIG. 13. Therefore, the device 100 may perform the steps illustrated in FIG. 13 to reduce the capacity of data while acquiring the phase difference ϕ in the same manner.

$$ϕ = {tan}^{- 1} \frac{( {C}_{1} - {C}_{3} )}{( {C}_{0} - {C}_{2} )} = {tan}^{- 1} \frac{( {C}_{1} - {Δ}_{q} ) / {2}^{α} - ( {C}_{3} - {Δ}_{q} ) / {2}^{α}}{( {C}_{0} - {Δ}_{i} ) / {2}^{α} - ( {C}_{2} - {Δ}_{i} ) / {2}^{α}} \qquad ( 7 )$$

According to the second method, the device 100 may acquire a compressed data set having a capacity reduced compared to that of each piece of pixel data while maintaining the pieces of pixel data (e.g., C₀, C₁, C₂, and C₃) acquired from respective detection nodes (e.g., 161, 162, 171, and 172).

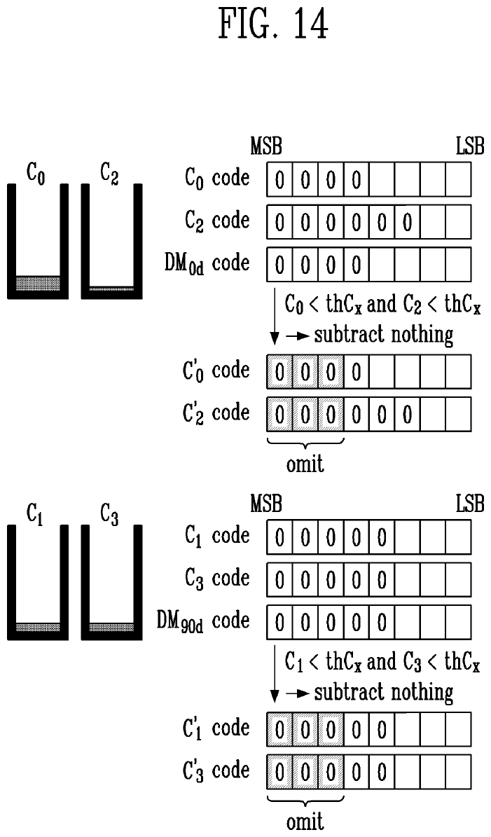

In FIGS. 14 to 17, a detailed example in which the device 100 performs the steps of FIG. 13 and then compresses pixel data depending on the situation around the device 100 will be described. In FIGS. 14 to 17, first to fourth situations may correspond to the first to fourth situations described in FIGS. 9 to 12.

FIG. 14 is a diagram illustrating an example of a compressed data set acquired in a first situation according to the second method among embodiments of the present disclosure.

The device 100 (e.g., the data compression module 140) may omit a third number of bits including a MSB from each of first pixel data C₀, second pixel data C₂, third pixel data C₁, and fourth pixel data C₃ in response to determination that, of first differential data DM_{0d} and second differential data DM_{90d}, the first differential data DM_{0d} having a larger value is less than a second threshold value thCx (e.g., 0x100000). Here, because all of C₀, C₂, C₁, and C₃ are less than the second threshold value thCx, the specific value might not be subtracted from each of C₀, C₂, C₁, and C₃.

Referring to FIG. 14, the device 100 may acquire first compressed data C′₀ by omitting a 3-digit code (of 0's) starting from a MSB from the first pixel data C₀, may acquire second compressed data C′₂ by omitting a 3-digit code (of 0's) starting from a MSB from the second pixel data C₂, may acquire third compressed data C′₁ by omitting a 3-digit code (of 0's) starting from a MSB from the third pixel data C₁, and may acquire fourth compressed data C′3 by omitting a 3-digit code (of 0's) starting from a MSB from the fourth pixel data C₃.

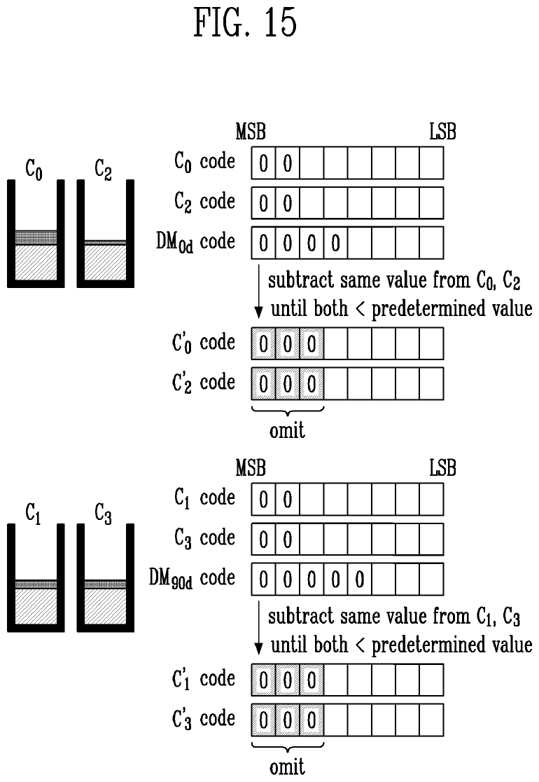

FIG. 15 is a diagram illustrating an example of a compressed data set acquired in a second situation according to the second method among embodiments of the present disclosure.

The device 100 (e.g., the data compression module 140) may omit a third number of bits including a MSB from each of first pixel data C₀, second pixel data C₂, third pixel data C₁, and fourth pixel data C₃ in response to determination that, of first differential data DM_{0d} and second differential data DM_{90d}, the first differential data DM_{0d} having a larger value is less than a second threshold value thCx (e.g., 0x100000).

Here, unlike the case of FIG. 14, in the example of FIG. 15, a specific value may be subtracted from each of C₀, C₂, C₁, and C₃ so that C₀, C₂, C₁, and C₃ becomes less than the second threshold value thCx. For example, the value described at steps S1322 and S1330 of FIG. 13 may be subtracted from each of C₀, C₂, C₁, and C₃.

Referring to FIG. 15, the device 100 may acquire first compressed data C′₀ by omitting a 3-digit code (of 0's) starting from a MSB from the first pixel data C₀ from which the preset value is subtracted, may acquire second compressed data C′₂ by omitting a 3-digit code (of 0's) starting from a MSB from the second pixel data C₂ from which the preset value is subtracted, may acquire third compressed data C′₁ by omitting a 3-digit code (of 0's) starting from a MSB from the third pixel data C₁ from which the preset value is subtracted, and may acquire fourth compressed data C′3 by omitting a 3-digit code (of 0's) starting from a MSB from the fourth pixel data C₃ from which the preset value is subtracted.

Comparing FIG. 14 and FIG. 15 with each other, in FIG. 14, a fifth bit from the LSB of C′₀+C′₂ may be 0, whereas, in FIG. 15, a fifth bit from the LSB of C′₀+C′₂ might not be 0. Compared to the first situation, the second situation indicates the situation in which ambient light is present, and thus a difference of C′₀+C′₂ may be present between FIGS. 14 and 15.

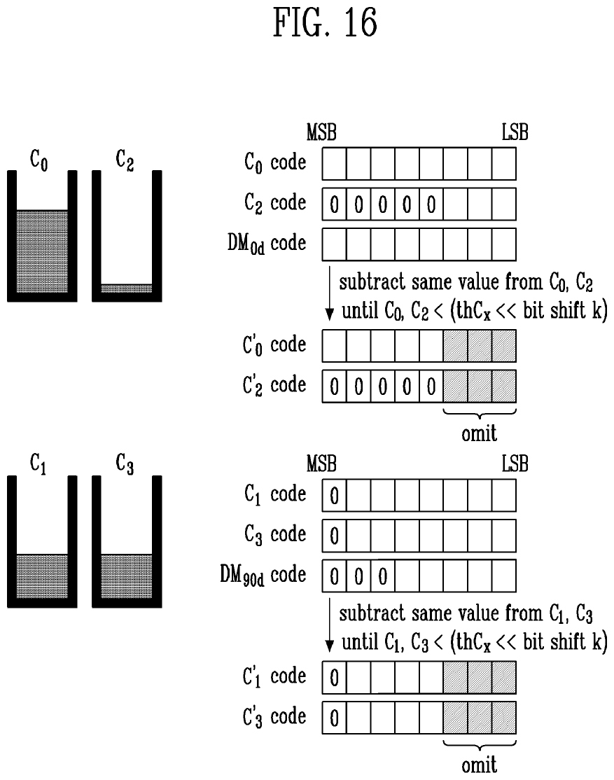

FIG. 16 is a diagram illustrating an example of a compressed data set acquired in a third situation according to the second method among embodiments of the present disclosure.

The device 100 (e.g., the data compression module 140) may acquire first compressed data C′₀, second compressed data C′₂, third compressed data C′₁, and fourth compressed data C′3, each including the MSB of the corresponding pixel data, by omitting a third number of bits from each of first pixel data C₀, second pixel data C₂, third pixel data C₁, and fourth pixel data C₃ in response to determination that, of first differential data DM_{0d} and second differential data DM_{90d}, the first differential data DM_{0d} having a larger value is equal to or greater than the second threshold value thCx (e.g., 0x100000).

Here, the device 100 (e.g., the data compression module 140) may subtract a preset value from each of the first pixel data C₀ and the second pixel data C₂ and acquire the first compressed data C′₀ and the second compressed data C′₂ based on the resulting first pixel data C₀ and the resulting second pixel data C₂ in response to determination that at least one of the first pixel data C₀ or the second pixel data C₂ is equal to or greater than a third threshold value (thCx<<k). Further, the device 100 (e.g., the data compression module 140) may subtract the preset value from each of the third pixel data C₁ and the fourth pixel data C₃ and acquire the third compressed data C′₁ and the fourth compressed data C′₄ based on the resulting third pixel data C₁ and the resulting fourth pixel data C₃ in response to determination that at least one of the third pixel data C₁ or the fourth pixel data C₃ is equal to or greater than the third threshold value (thCx<<k).

That is, because the device 100 bit-shifts the pixel data to the right by k and thereafter omits a 3-digit code (of 0's) starting from a MSB, the 3-digit code starting from the LSB of the corresponding differential data may be omitted.

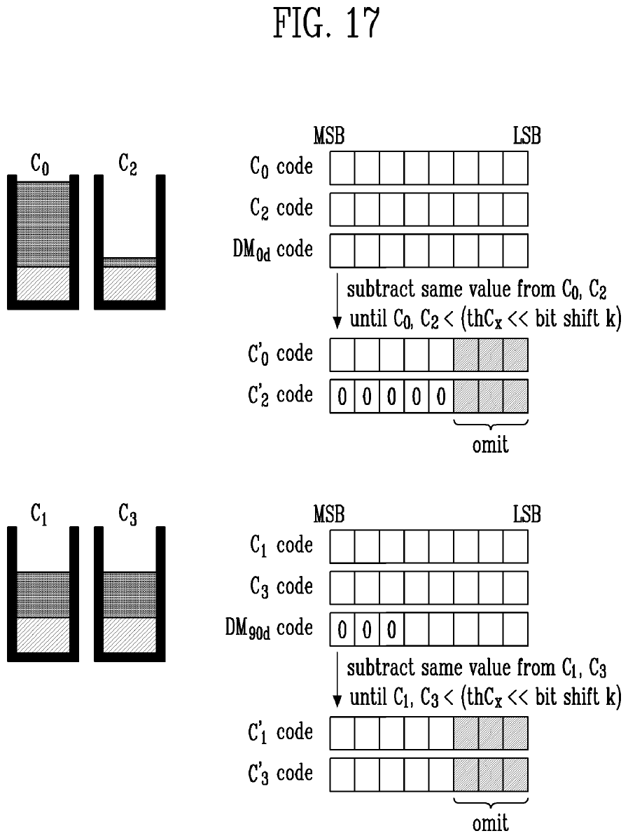

FIG. 17 is a diagram illustrating an example of a compressed data set acquired in a fourth situation according to the second method among embodiments of the present disclosure.

The device 100 (e.g., the data compression module 140) may acquire first compressed data C′₀, second compressed data C′₂, third compressed data C′₁, and fourth compressed data C′₃, each including the MSB of the corresponding pixel data, by omitting a third number of bits from each of first pixel data C₀, second pixel data C₂, third pixel data C₁, and fourth pixel data C₃ in response to determination that, of first differential data DM_{0d} and second differential data DM_{90d}, the first differential data DM_{0d} having a larger value is equal to or greater than a second threshold value thCx (e.g., 0x100000).

Here, the device 100 (e.g., the data compression module 140) may subtract a preset value from each of the first pixel data C₀ and the second pixel data C₂ and acquire the first compressed data C′₀ and the second compressed data C′₂ based on the resulting first pixel data C₀ and the resulting second pixel data C₂ in response to determination that at least one of the first pixel data C₀ or the second pixel data C₂ is equal to or greater than a third threshold value (thCx<<k). Further, the device 100 (e.g., the data compression module 140) may subtract the preset value from each of the third pixel data C₁ and the fourth pixel data C₃ and acquire the third compressed data C′₁ and the fourth compressed data C′4 based on the resulting third pixel data C₁ and the resulting fourth pixel data C₃ in response to determination that at least one of the third pixel data C₁ or the fourth pixel data C₃ is equal to or greater than the third threshold value (thCx<<k).

That is, because the device 100 bit-shifts the pixel data to the right by k and thereafter omits a 3-digit code (of 0's) starting from a MSB, the 3-digit code starting from the LSB of the corresponding differential data may be omitted.

Comparing FIG. 16 and FIG. 17 with each other, in FIG. 16, the MSB of C′₁+C′₃ may be 0, whereas, in FIG. 17, the MSB of C′₁+C′₃ might not be 0. Compared to the third situation, the fourth situation indicates the situation in which ambient light is present, and thus a difference of C′₁+C′₃ may be present between FIGS. 16 and 17.

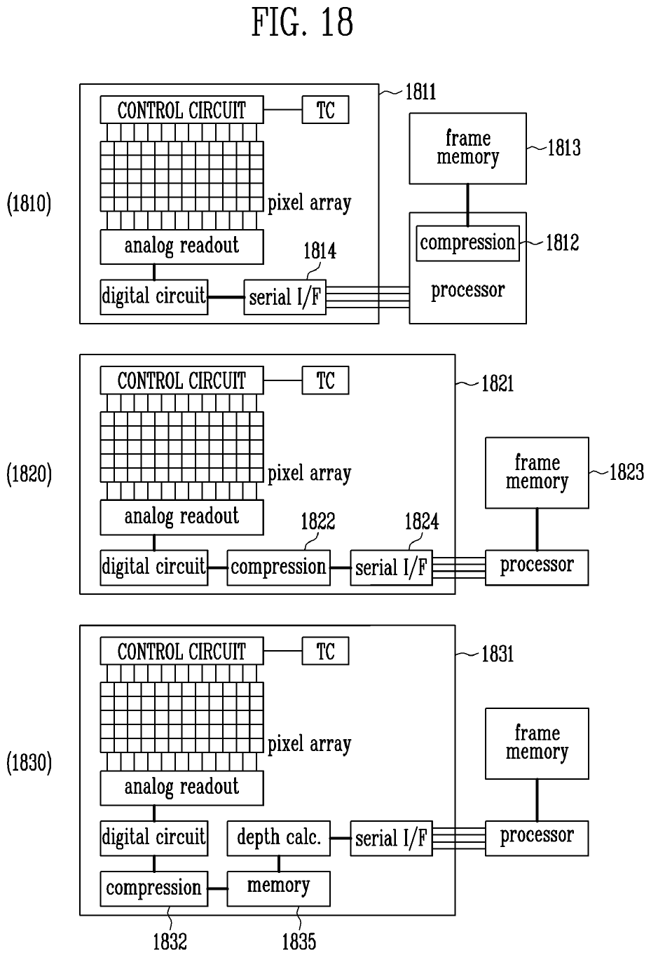

FIG. 18 is a diagram illustrating the hardware configuration of a device according to various embodiments of the present disclosure.

The device 100 may acquire pieces of pixel data through a pixel array 130 included in an image sensor (TOF sensor) 1811, 1821, or 1831. The device 100 may generate pieces of compressed data based on the pieces of pixel data through a data compression module 1812, 1822, or 1832 (e.g., the data compression module 140 of FIG. 1), and may store the generated compressed data in a frame memory 1813 or 1823. Here, the device 100 may include the data compression module 1812, 1822, or 1832 arranged at various positions.

For example, as indicated by reference numeral 1810, the data compression module 1812 may be arranged outside the image sensor 1811. When the data compression module 1812 is arranged at the rear end of a serial interface 1814, the data compression module 1812 compresses data, and thus the storage space of the frame memory 1813 may be saved.

In an example, as indicated by reference numeral 1820, the data compression module 1822 may be arranged inside the image sensor 1821. When the data compression module 1822 is arranged at the front end of a serial interface 1824, the data compression module 1822 compresses data, and thus the bandwidth of the serial interface 1824 and the storage space of the frame memory 1823 may be saved.

In an example, as indicated by reference numeral 1830, the data compression module 1832 and a memory 1835 may be arranged inside the image sensor 1831. The memory 1835 arranged in the image sensor may be referred to as an “on-sensor memory.” When data is compressed by the data compression module 1832 in the image sensor 1831, the storage space of the on-sensor memory 1835 may be saved.

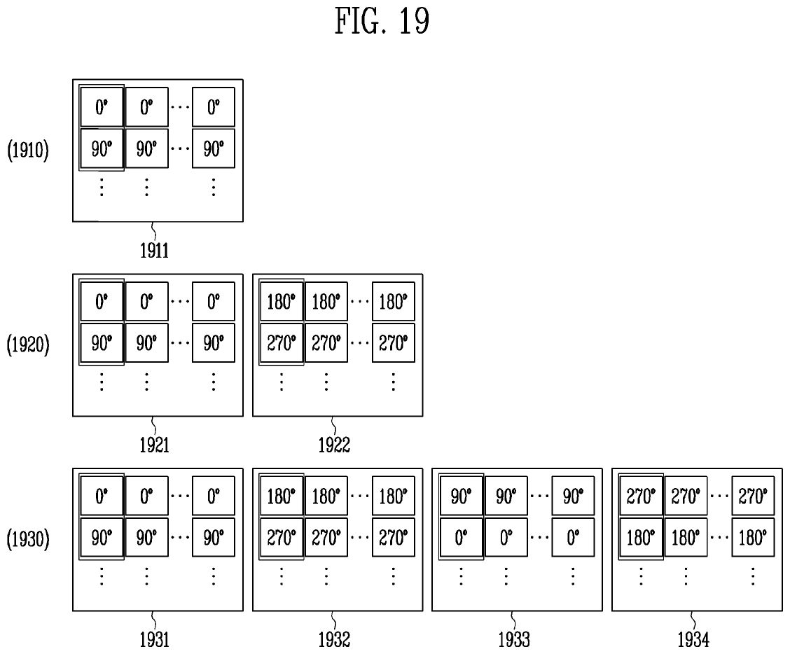

FIG. 19 is a diagram illustrating the phases of modulation voltages applied to unit pixels for respective frames according to various embodiments of the present disclosure.

Referring to reference numeral 1910, the device 100 may apply a first modulation voltage having a designated phase to a first control node 163 of a first unit pixel 160 and apply a third modulation voltage having a phase difference of 90 degrees from the designated phase to a third control node 173 of a second unit pixel 170. In reference number 1910, the device 100 may calculate the depth of an external object 1 based on pixel data acquired through a first image frame 1911. When a scheme indicated by reference numeral 1910 is used, the device 100 may calculate the depth of the external object 1 on the fly even though pixel data or differential data is not temporarily stored or in some embodiments differential data is not stored.

Referring to reference numeral 1920, the device 100 may apply the first modulation voltage having the designated phase to the first control node 163 of the first unit pixel 160 and apply the third modulation voltage having a phase difference of 90 degrees from the designated phase to the third control node 173 of the second unit pixel 170 in a first image frame 1921. Further, the device 100 may apply a fifth modulation voltage having a phase difference of 180 degrees from the designated phase to the first control node 163 of the first unit pixel 160 and apply a seventh modulation voltage having a phase difference of 270 degrees from the designated phase to the third control node 173 of the second unit pixel 170 in a second image frame 1922. In reference number 1920, the device 100 may calculate the depth of the external object 1 based on pieces of pixel data acquired through two image frames, that is, the first image frame 1921 and the second image frame 1922. When a scheme indicated by reference numeral 1920 is used, the device 100 may reduce faults attributable to an error occurring when two detection nodes in each unit pixel are controlled or driven.

Referring to reference numeral 1930, the device 100 may apply the first modulation voltage having the designated phase to the first control node 163 of the first unit pixel 160 and apply the third modulation voltage having a phase difference of 90 degrees from the designated phase to the third control node 173 of the second unit pixel 170 in a first image frame 1931. Further, the device 100 may apply a modulation voltage having a phase difference of 180 degrees from the designated phase to the first control node 163 of the first unit pixel 160 and apply a modulation voltage having a phase difference of 270 degrees from the designated phase to the third control node 173 of the second unit pixel 170 in a second image frame 1932. Furthermore, the device 100 may apply a modulation voltage having a phase difference of 90 degrees from the designated phase to the first control node 163 of the first unit pixel 160 and apply a modulation voltage having the designated phase to the third control node 173 of the second unit pixel 170 in a third image frame 1933. Furthermore, the device 100 may apply a modulation voltage having a phase difference of 270 degrees from the designated phase to the first control node 163 of the first unit pixel 160 and apply a modulation voltage having a phase difference of 180 degrees from the designated phase to the third control node 173 of the second unit pixel 170 in a fourth image frame 1934. In reference number 1930, the device 100 may calculate the depth of the external object 1 based on the pieces of pixel data acquired through four image frames, that is, the first image frame 1931, the second image frame 1932, the third image frame 1933, and the fourth image frame 1934. In an embodiment, when a scheme indicated by reference numeral 1930 is used, the device 100 may further reduce failures attributable to a control error or driving error between detection nodes, and may improve identification accuracy when calculating the depth of the external object 1.

According to an embodiment of the present disclosure, the capacity of data required for the generation of a depth image using a TOF sensor may be reduced by compressing acquired pixel data or differential data. Accordingly, in an embodiment, the size of storage space of a frame memory may be reduced, and the bandwidth of a serial interface may be saved.

What is claimed is:

1. A device, comprising:
a first unit pixel to which a first modulation voltage having a designated phase and a second modulation voltage having a phase difference of substantially 180 degrees from the first modulation voltage are applied;
a second unit pixel to which a third modulation voltage having a phase difference of substantially 90 degrees from the first modulation voltage and a fourth modulation voltage having a phase difference of 180 degrees from the third modulation voltage are applied; and
a data compression module configured to generate a compressed data set including data that is compressed compared to pixel data received from the first unit pixel and the second unit pixel based on the pixel data.

2. The device according to claim 1, further comprising:
a light source configured to output modulated light corresponding to the designated phase.

3. The device according to claim 1, wherein the first unit pixel comprises:
a first control node to which the first modulation voltage is applied;
a second control node to which the second modulation voltage is applied; and
a first detection node and a second detection node configured to capture a first photocharge generated based on reflected light that is modulated light reflected from an external object, wherein the modulated light corresponds to the designated phase.

4. The device according to claim 3, wherein the second unit pixel comprises:
a third control node to which the third modulation voltage is applied;
a fourth control node to which the fourth modulation voltage is applied; and
a third detection node and a fourth detection node configured to capture a second photocharge generated based on the reflected light.

5. The device according to claim 4, wherein the data compression module is configured to:
receive first pixel data, second pixel data, third pixel data, and fourth pixel data, each including a first number of bits, from the first detection node, the second detection node, the third detection node, and the fourth detection node, respectively, and
generate the compressed data set including the compressed data that includes a second number of bits less than the first number of bits, based on the first pixel data, the second pixel data, the third pixel data, and the fourth pixel data.

6. The device according to claim 5, further comprising:
a distance measurement module configured to calculate a distance to the external object based on the compressed data set.

7. The device according to claim 5, wherein the data compression module is configured to:
acquire first differential data corresponding to a difference between the first pixel data and the second pixel data and acquire second differential data corresponding to a difference between the third pixel data and the fourth pixel data, wherein each of the first differential data and the second differential data includes the first number of bits,
acquire first compressed data having the second number of bits by omitting a part of bits of the first differential data, and
acquire second compressed data having the second number of bits by omitting a part of bits of the second differential data.

8. The device according to claim 7, wherein the data compression module is configured to acquire the first compressed data and the second compressed data based on whether, of the first differential data and the second differential data, differential data having a larger value is less than a first threshold value.

9. The device according to claim 8, wherein the data compression module is configured to:
in response to a determination that, of the first differential data and the second differential data, the differential data having a larger value is less than the first threshold value, acquire the first compressed data by omitting a third number of bits including a most significant bit (MSB) from the first differential data, and acquire the second compressed data by omitting a third number of bits including a MSB from the second differential data.

10. The device according to claim 8, wherein the data compression module is configured to:
in response to a determination that, of the first differential data and the second differential data, differential data having a larger value is equal or greater than the first threshold value, acquire the first compressed data including a MSB of the first differential data by omitting the part of the bits of the first differential data and acquire the second compressed data including a MSB of the second differential data by omitting the part of the bits of the second differential data.

11. The device according to claim 10, wherein the data compression module is configured to:
in response to a determination that, of the first differential data and the second differential data, differential data having the larger value is equal to or greater than the first threshold value, bit-shift the first differential data and the second differential data to the right,
determine whether, of bit-shifted first differential data and bit-shifted second differential data, data having a larger value is less than the first threshold value, and
in response to a determination that, of the bit-shifted first differential data and the bit-shifted second differential data, the data having a larger value is less than the first threshold value, acquire the first compressed data by omitting a third number of bits including a MSB from the bit-shifted first differential data, and acquire the second compressed data by omitting the third number of bits including a MSB from the bit-shifted second differential data.

12. The device according to claim 5, wherein the data compression module is configured to acquire first compressed data, second compressed data, third compressed data, and fourth compressed data, each having the second number of bits, by omitting a third number of bits from each of the first pixel data, the second pixel data, the third pixel data, and the fourth pixel data.

13. The device according to claim 12, wherein the data compression module is configured to determine positions of bits to be omitted based on first differential data corresponding to a difference between the first pixel data and the second pixel data and second differential data corresponding to a difference between the third pixel data and the fourth pixel data.

14. The device according to claim 13, wherein the data compression module is configured to:
in response to a determination that, of the first differential data and the second differential data, differential data having a large value is less than a second threshold value, omit the third number of bits including a MSB from each of the first pixel data, the second pixel data, the third pixel data, and the fourth pixel data.

15. The device according to claim 13, wherein the data compression module is configured to:
in response to a determination that, of the first differential data and the second differential data, differential data having a large value is equal to or greater than a second threshold value, acquire the first compressed data, the second compressed data, the third compressed data, and the fourth compressed data, each MSB of the corresponding pixel data, by omitting the third number of bits from each of the first pixel data, the second pixel data, the third pixel data, and the fourth pixel data.

16. The device according to claim 12, wherein the data compression module is configured to:
in response to a determination that at least one of the first pixel data or the second pixel data is equal to or greater than a third threshold value, subtract a preset value from each of the first pixel data and the second pixel data and acquire the first compressed data and the second compressed data based on resulting first pixel data and resulting second pixel data, and
in response to a determination that at least one of the first pixel data or the second pixel data is equal to or greater than the third threshold value, subtract the preset value from each of the third pixel data and the fourth pixel data and acquire the third compressed data and the fourth compressed data based on resulting third pixel data and resulting fourth pixel data.

17. A method, comprising:
outputting modulated light corresponding to a designated phase through a light source;
generating a first photocharge corresponding to reflected light that is modulated light reflected from an external object through a first unit pixel, and generating a second photocharge corresponding to the reflected light through a second unit pixel;
capturing the first photocharge by applying a first modulation voltage having the designated phase and a second modulation voltage having a phase difference of substantially 180 degrees from the first modulation voltage to the first unit pixel, and capturing the second photocharge by applying a third modulation voltage having a phase difference of substantially 90 degrees from the first modulation voltage and a fourth modulation voltage having a phase difference of substantially 180 degrees from the third modulation voltage to the second unit pixel;
acquiring pixel data through the first unit pixel and the second unit pixel; and
generating a compressed data set including data that is compressed compared to the pixel data based on the pixel data.

18. The method according to claim 17, wherein acquiring the pixel data through the first unit pixel and the second unit pixel comprises:
acquiring first pixel data through a first detection node by applying the first modulation voltage to a first control node, acquiring second pixel data through a second detection node by applying the second modulation voltage to a second control node, acquiring third pixel data through a third detection node by applying the third modulation voltage to a third control node, and acquiring fourth pixel data through a fourth detection node by applying the fourth modulation voltage to a fourth control node.

19. The method according to claim 18, wherein generating the compressed data set comprises:
generating the compressed data having a second number of bits less than a first number of bits based on the first pixel data, the second pixel data, the third pixel data, and the fourth pixel data, each including the first number of bits.

20. The method according to claim 19, further comprising:
calculating a distance to the external object based on the compressed data set.

21. The method according to claim 19, wherein generating the compressed data set comprises:
acquiring first differential data corresponding to a difference between the first pixel data and the second pixel data and acquiring second differential data corresponding to a difference between the third pixel data and the fourth pixel data, wherein each of the first differential data and the second differential data has the first number of bits; and
acquiring first compressed data having the second number of bits by omitting a part of bits of the first differential data and acquiring second compressed data having the second number of bits by omitting a part of bits of the second differential data.

22. The method according to claim 21, wherein acquiring the first compressed data and the second compressed data comprises:
in response to a determination that, of the first differential data and the second differential data, differential data having a larger value is less than a first threshold value, acquiring the first compressed data by omitting a third number of bits including a most significant bit (MSB) from the first differential data, and acquiring the second compressed data by omitting the third number of bits including a MSB from the second differential data.

23. The method according to claim 21, wherein acquiring the first compressed data and the second compressed data comprises:
in response to a determination that on whether, of the first differential data and the second differential data, differential data having a larger value is equal or greater than a first threshold value, acquiring the first compressed data including a MSB of the first differential data by omitting the part of the bits from the first differential data and acquiring the second compressed data including a MSB of the second differential data by omitting the part of the bits from the second differential data.
